(19) United States
(12) Patent Application Publication
(10) Pub. No.: US 2009/0315668 A1
(43) Pub. Date: Dec. 24, 2009

(54) WIRING TOPOLOGY FOR A BUILDING WITH A WIRELESS NETWORK

(75) Inventors: Lawrence F. Leete, III, Spring Lake, MI (US); Thomas J. Doman, Holland, MI (US); R. Craig Klem, Spring Lake, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: Light Corporation, Grand Haven, MI (US)

(21) Appl. No.: 12/142,404

(22) Filed: Jun. 19, 2008

(51) Int. Cl. G05B 23/02

(52) U.S. Cl. 340/3.1

(57) ABSTRACT

A power and control system for minimizing home-run power lines to fixtures located throughout a building and wirelessly controlling fixtures according to zones defined irrespective of their wiring. Less “pipe and box” is necessary when branch circuits are not used to define zones. A building may be wired in order to minimize costs, while increasing flexibility and reliability by implementing wireless zone control.

### BACKGROUND OF THE INVENTION

The present invention relates to wiring topology, and more particularly to improvements in wiring topology such that wiring is more cost efficient, but maintains reliability and flexibility.

Downtime between tenants in buildings is a leading cause of lost income for owners, developers and realtors. As buildings change hands, often they are rearranged for different uses. One of the largest costs to a new owner is the cost associated with moves, adds and changes to the wiring of the building in order to accommodate these different uses.

Many buildings are wired using home-run wiring topology, as shown in FIG. 1. That is, multiple home-run power lines 10, 12, 14, 16 span from an electrical panel 1 to various devices 2, 4, 6, 8 in the building. The wiring is configured such that all devices connected to the same home-run are controlled by the same breaker and constitute one zone. Changing which devices are controlled by a breaker requires physically rewiring the device, which is often inconvenient and costly.

Some systems have addressed this issue by installing wireless modules to control the devices regardless of its home-run. Because the modules are controlled wirelessly, no physical rewiring is necessary. However, these solutions do nothing to optimize the wiring topology of the building, which is cost inefficient.

### SUMMARY OF THE INVENTION

The aforementioned problems are overcome by the present invention wherein the wiring topology of a building minimizes the amount of wiring and provides wireless control of the devices. The wiring topology for a building may be designed irrespective of the desired zones. That is, the number of desired zones need not be a factor in determining the number of home-run power lines or the number of circuit breakers.

These and other objects, advantages, and features of the invention will be more fully understood and appreciated by reference to the description of the current embodiment and the drawings.

### BRIEF DESCRIPTION OF THE DRAWINGS

FIG. 1 illustrates the prior art wiring topology of a building.

FIG. 2 illustrates the wiring topology of one embodiment of the present invention.

FIG. 3 illustrates the wiring topology of another embodiment of the present invention.

FIG. 4 illustrates a block diagram of a control panel.

FIG. 5 illustrates a block diagram of one embodiment of a node.

FIG. 6 illustrates a block diagram of a node connected to a plurality of fixtures and sensors.

FIG. 7 illustrates a block diagram of an electrical panel.

FIG. 8 illustrates the wiring topology of another embodiment of the present invention and illustrates the minimization of “pipe and box.”

FIG. 9 illustrates the wiring topology of another embodiment of the present invention where a building is retrofit to minimize the number of circuit breakers.

### DESCRIPTION OF THE CURRENT EMBODIMENT

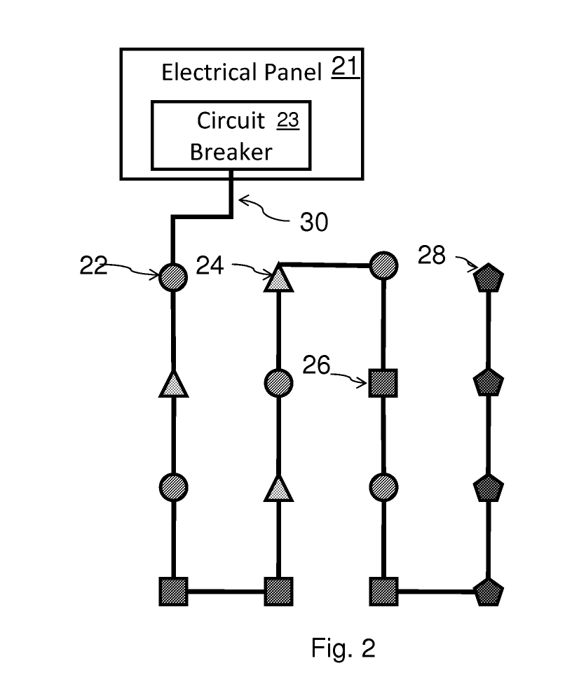

A power and control system in accordance with an embodiment of the present invention is shown in FIG. 2. The power and control system includes an electrical panel 21, a plurality of nodes 22, 24, 26, 28, and a home-run 30. In the illustrated embodiment, the nodes 22, 24, 26, 28 are wired in series with a single home-run in order to minimize the amount of wiring in the power and control system. In other embodiments, the nodes 22, 24, 26, 28 may be wired differently to minimize the amount of wiring and may include additional home-runs to the extent they are necessary to accommodate the load. As will be described in more detail later, each of the nodes may be controlled wirelessly. Wireless control allows nodes to be in different zones despite being connected to the same home-run power line to the electrical panel. This wiring topology in combination with wireless node control provides cost efficiency, reliability, and flexibility that is generally unattainable with traditional power and control systems.

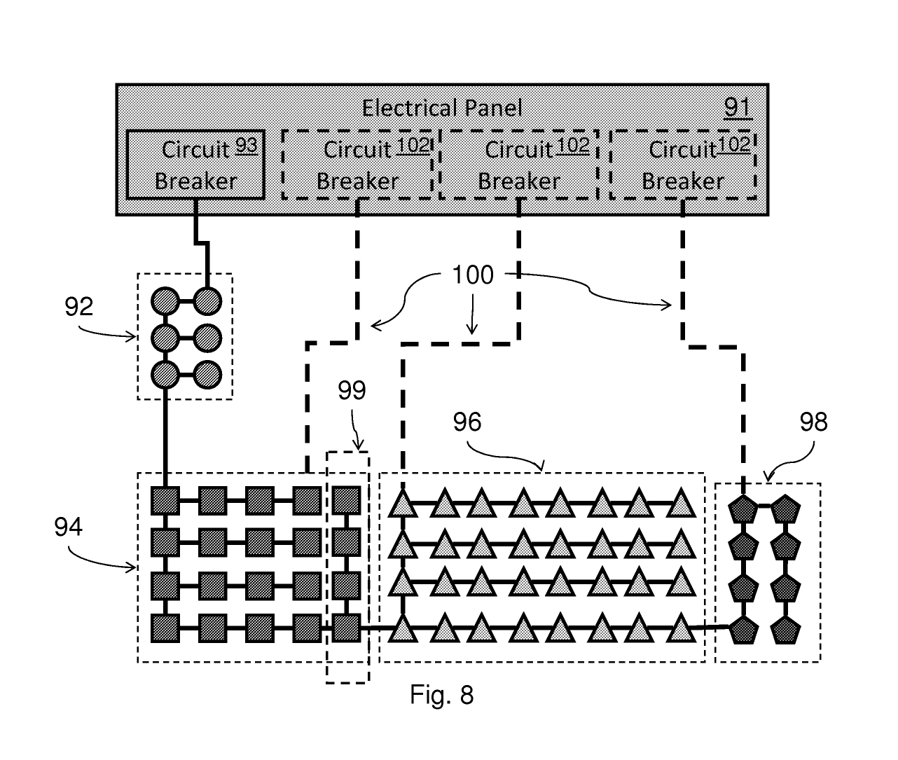

The power and control system of the illustrated embodiment includes electrical paths that are not constrained by traditional wiring topology or architecture. Buildings are wired in order to minimize “pipe and box,” and need not accommodate the zonal layout of the building. Perhaps as best illustrated in FIG. 8, one embodiment of the present invention results in fewer home-runs 100 and fewer circuit breakers 93 (unnecessary home-runs 100 and circuit breakers 102 are shown in broken lines). This “pipe and box” is no longer necessary because of the wireless control provided by the wireless controller (not shown in the FIG. 8 embodiment). Various zones 92, 94, 96, 98 may be defined using the controller irrespective of their connections to the electrical panel. Desired changes to the zoning may be accomplished in software. For example, in the illustrated embodiment, the power and control system is a lighting system that defines four zones 92, 94, 96, 98. A user that desires to rezone these areas differently need only change the zonal mapping in software. For example, the nodes 99 may be easily moved from zone 94 to zone 96 without any rewiring by changing the zoning in software. Although the illustrated embodiment shows a mere four zones with a small number of nodes for simplicity, this concept is easily applied to large buildings with thousands of nodes and many more zones. The total “pipe and box” savings is greatly enhanced by the number of nodes and zones in the system.

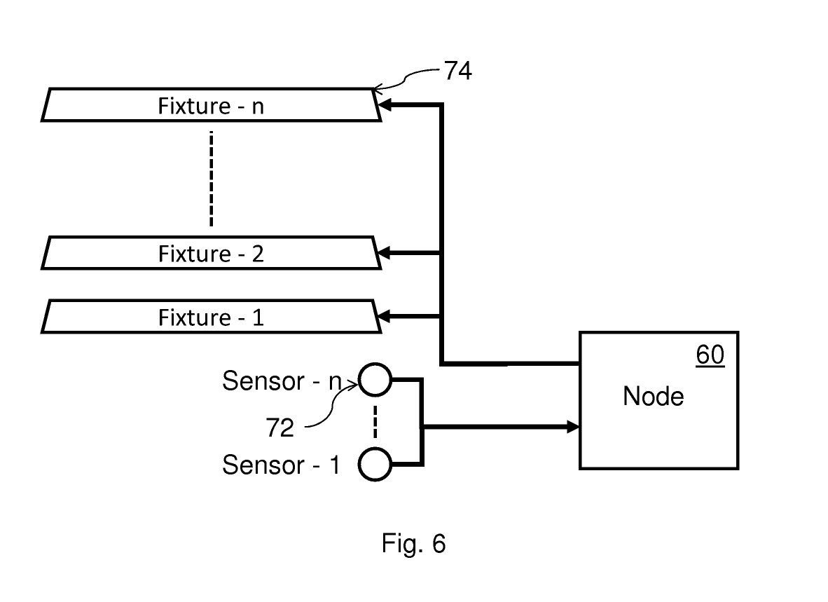

The power and control system of the illustrated embodiments may be used to provide power to essentially any suitable devices. Perhaps as best shown in FIG. 6, in the illustrated embodiment, each node of the system may be connected to one or more fixtures 74 and one or more sensors 72. In some embodiments, each of the nodes may include one or more fixtures and one or more sensors. In one embodiment, the power and control system is a lighting power and control system where each node is a lighting control node that is connected to one or more lighting fixtures. In other embodiments, the power and control system may be capable of providing power and control to all of a building, including lights, power receptacles and any other devices connected to the system.

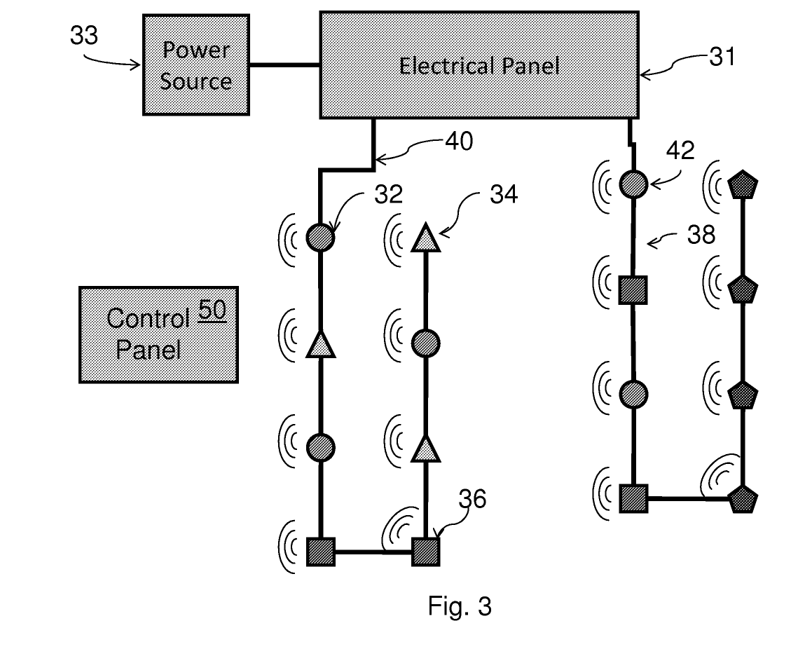

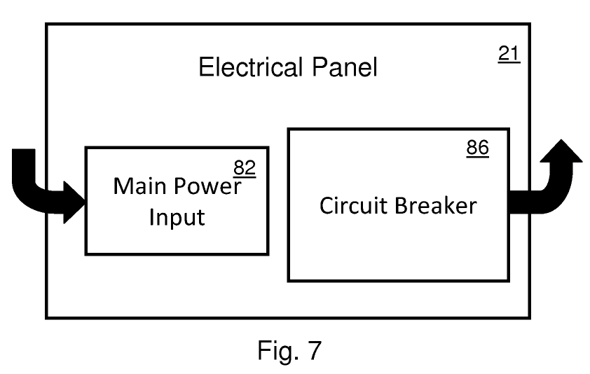

A block diagram of one embodiment of the electrical panel is illustrated in FIG. 7 and generally designated 21. The electrical panel generally includes a main power input 82 and one or more circuit breakers 86. The main power input 82 accepts and optionally conditions the power for the building. Perhaps as best shown in FIG. 3, a power source 33 is connected to the electrical panel 31. In the illustrated embodiment, the power source is a conventional power line. For example, a 277V or 480V AC power source may be used. The circuit breaker 86, sometimes referred to as a control breaker, controls the flow of power to the home-run power lines.

Referring back to FIG. 2, in the illustrated embodiment, each of the nodes 22, 24, 26, 28 includes an intelligent wireless transceiver, such as a ZigBee module which can be purchased from Ember, whose headquarters are located at 47 Farnsworth Street in Boston Mass. In alternative embodiments, other communication circuitry may be used. For example, Bluetooth, RFID or other wireless transmission techniques known to those skilled in the art may be used. Although the nodes of the illustrated embodiments are described as having receivers for the sake of simplicity, in more complex embodiments, the nodes may include a transceiver to facilitate bi-directional communication with a controller or other nodes. In other embodiments, the nodes may form a wireless mesh network. For example, the nodes may form a wireless mesh network such as the one disclosed in U.S. patent application Ser. No. 12/141,759, which is entitled “Wireless Mesh Network” and was filed on Jun. 18, 2008 in the name of Schenk et al.

Wireless mesh networks are known. Nodes are placed throughout a facility and in general, communication is effected by having each node rebroadcast any message it receives until the designated recipient receives the signal. This allows messages to propagate through the network to their destination. A number of different wireless mesh network protocols are also known, any of which are suitable for use in the present invention. Wireless mesh networks enable a vast amount of control and flexibility. Some wireless mesh networks may be used to control lighting. Because of the flexibility afforded by the mesh network, different light zones may be mapped in software, without rewiring the nodes.

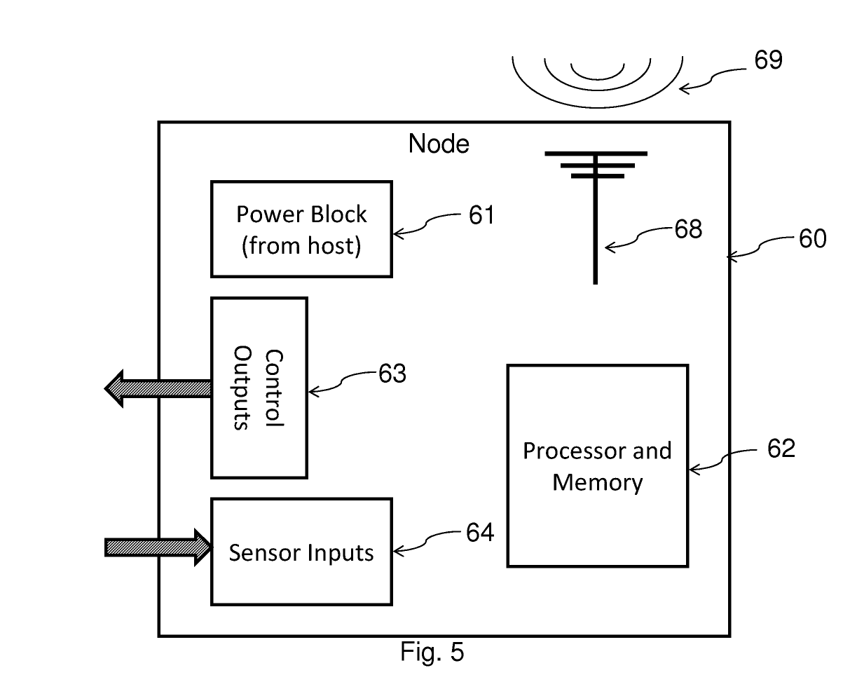

An exemplary node is depicted in more detail in FIG. 5, and generally designated 60. The illustrated node includes a power block 61, one more control outputs 63, one or more optional sensor inputs 64, a processor and memory 62, and a receiver 68. The power block 61 includes conditioning circuitry for the power input. Power may be provided via power shared with the fixture being controlled or by a connection to the electrical panel via a home-run power line.

The control output 63 includes circuitry and logic to drive the connected fixture. The control may be provided through a wired or wireless connection. In some embodiments, the control output may be integrated into the processor and memory 62. As described above, an exemplary embodiment of a node controlling a number of fixtures is depicted in FIG. 6. In the illustrated embodiment, the control output of node 60 is electrically connected to each of the fixtures 74. In alternative embodiments, the node 60 may be integrated directly into one or each of the fixtures 74. In yet another alternative embodiment, the node 60 may wirelessly communicate with the fixtures 74.

Referring back to FIG. 5, the optional sensor inputs 64 may accept input from a variety of different optional sensors that may be installed within the power and control system. In the embodiment illustrated in FIG. 6, a number of sensors 72 are installed and provide input to node 70. In one embodiment, the sensors 72 include an occupancy sensor and photo-sensor that assist in determining when the lighting fixtures should be enabled.

The receiver 68 in node 60 may receive commands from a wireless controller. Typically, commands are generated by the controller and wirelessly transmitted to the receiver 68 of the node in the form of wireless signal 69. The node 60 processes and executes the received instructions. As discussed above, in some alternative embodiments receiver 68 may be replaced with a more generic transceiver, so that the node can both send and receive signals. Transceivers and receivers are both generally known and essentially any suitable component may be used to provide wireless communication in the present invention.

The processor and memory 62 includes intelligence and storage for command and control. The processor and memory 62 are known components and thus will not be described in detail. In the illustrated embodiment, the processor and memory 62 include intelligence relating to a wireless mesh network protocol. The processor and memory 62 of the current embodiment are capable of executing instructions received from the controller, interpreting sensor feedback and generally controlling any fixtures associated with the node 60.

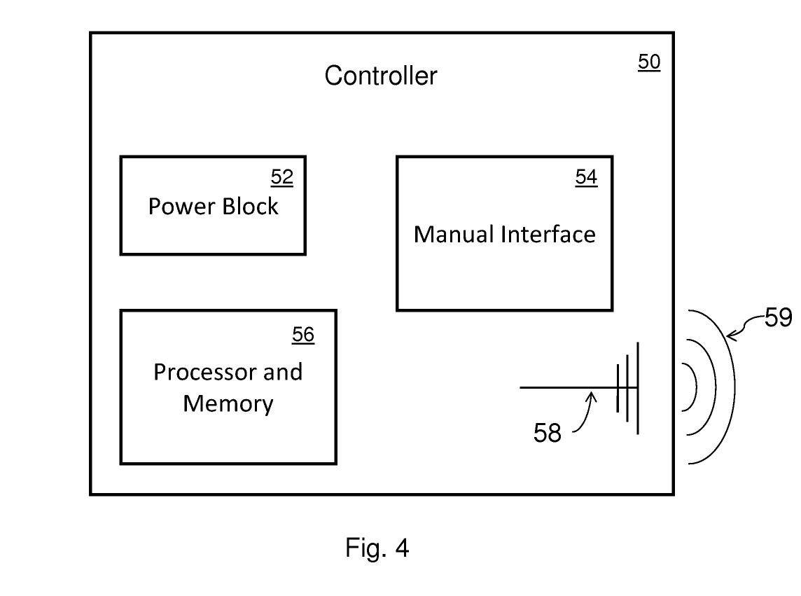

Commands may originate from a controller. A controller is shown generally in FIG. 3 with respect to the rest of the power and control system. An exemplary controller is illustrated in more detail in the block diagram of FIG. 4, and generally designated 50. The controller 50 of the illustrated embodiment includes a power block 52, a processor and memory 56, a manual interface 54, and a transmitter 58. The power block 52 provides power to the controller. In some embodiments, the controller may be a control panel powered by the electrical panel or in other embodiments, the controller may be a mobile controller, such as a laptop or remote control that is powered by batteries. The processor and memory 56 include intelligence and storage for command and control of the nodes. The protocols and software for providing control of wireless nodes are known and will therefore not be described in detail. Suffice it to say that the controller is capable of mapping the nodes to the appropriate fixtures and providing various levels of control over those fixtures by wirelessly communicating instructions to the nodes. Essentially any protocol for wireless control may be implemented in the present invention. The transmitter 58 provides a mechanism for communicating with the nodes via wireless signals 59. Similar to the receiver in the exemplary node, the transmitter 58 may be replaced with a generic transceiver to enable two-way communication between the controller and nodes 32, 34, 42. In the illustrated embodiment the manual interface 54 allows a user to send commands to manipulate the fixtures or to set up different zones.

It is conceivable that in some situations additional home-runs may reduce the amount of wiring because the nodes to be wired are closer to the electrical panel than to another node. For example, the wiring topology of FIG. 3 depicts two home-run power lines 40, 38 to the electrical panel 31. Even in such a circumstance, there may be a savings in “box” because the home-runs 40, 38 may still be joined to a single circuit breaker, e.g. using a junction, inside or just outside the electrical panel. This is just one example of how wiring in the building may still be minimized even where multiple home-run power lines are used.

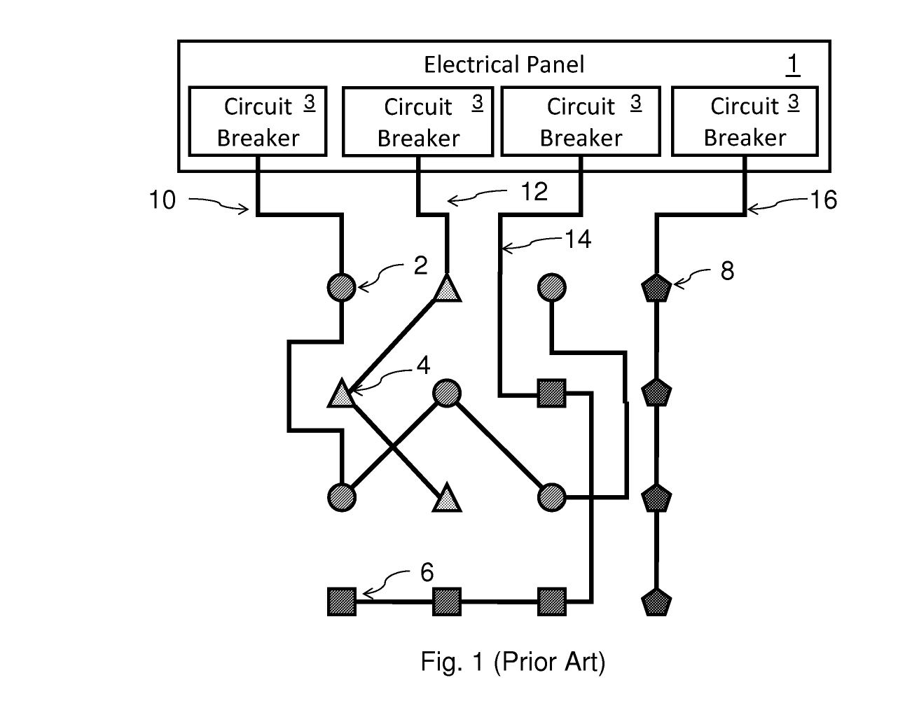

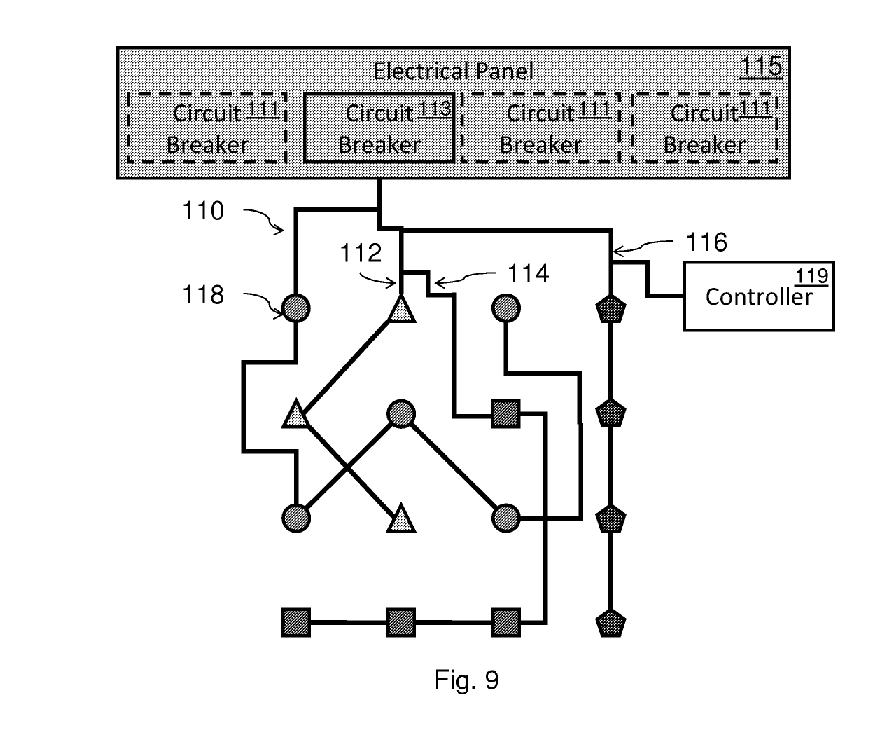

A system for retrofitting an existing building in order to consolidate home-runs to a single circuit breaker is illustrated in FIG. 9. The FIG. 1 (prior art) system may be retrofitted to reduce the number of circuit breakers. For example, in the retrofitted power and control system of FIG. 9, three circuit breakers 111 may be removed from the system. Home-runs 110, 112, 114 and 116 and may be consolidated to circuit breaker 113 of electrical panel 115. The fixtures 118 may be retrofitted with wireless control nodes (not shown) so that controller 119 can wirelessly control the fixtures 118. In the illustrated embodiment, controller 119 is a control panel that is powered by home-run 116. Although this retrofitting technique does not reduce the number of home-runs to the electrical panel 115, it does reduce the number of circuit breakers in the electrical panel. In some embodiments, home-runs are combined and connected to a single circuit breaker until the maximum rated load for a circuit breaker is met. This intentional maximum loading of the circuit breaker eliminates the number of circuit breakers required by the system, while maintain the flexibility of control through the wireless controller.

Intentionally loading the circuit breaker with the maximum rated load may also be helpful in new building construction. For example, referring to FIG. 3, in one embodiment home-runs 40, 38 are intentionally connected to the maximum number of fixtures and nodes allowed for their current rating. By loading each home-run to its maximum capacity, the amount of pipe and box, e.g. circuit breakers and home-runs, can be minimized.

In some embodiments, low power rated fixtures and nodes may be used throughout a facility such that only a single home-run is necessary for the entire building. As described above, a controller may communicate with the nodes wirelessly to control the fixtures as desired.

For simplicity, the figures described above in connection with the present invention do not show separate phase, ground and neutral lines. Further, it should be understood that each depicted node may represent essentially any combination of fixtures and nodes. That is, although the figures are depicted with a relatively small number of nodes and fixtures the concepts described above are applicable to systems with a large number of nodes and fixtures.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A power and control system for a building comprising:
an electrical panel electrically connected to a power source;
a plurality of nodes distributed throughout said building connected with a power wiring topology that substantially minimizes the amount of wire used in said building to provide power to said plurality of nodes and wherein each of said plurality of nodes is controlled wirelessly; and
a controller for providing wireless zone control of said plurality of nodes, wherein said plurality of nodes may be controlled irrespective of said power wiring topology.

2. The power and control system of claim 1 wherein said power wiring topology consists of one home-run from said plurality of nodes to said electrical panel.

3. The power and control system of claim 1 wherein each of said plurality of nodes are assigned to a first zone or a second zone wherein said controller separately controls said first zone and said second zone.

4. The power and control system of claim 3 wherein one or more of said plurality of nodes are reassigned to a different zone without changing the power wiring topology.

5. The power and control system of claim 1 wherein each of the plurality of nodes is a lighting control module integrated into a lighting fixture.

6. The power and control system of claim 1 wherein each of the plurality of nodes is connected to one or more lighting fixtures.

7. The power and control system of claim 6 wherein each of said plurality of nodes is powered by at least one of said connected lighting fixtures.

8. The power and control system of claim 6 wherein each of said plurality of nodes provides power to said one or more connected lighting fixtures.

9. A method of wiring and zoning a building with a wireless controller comprising:
installing an electrical panel in the building and connecting the electrical panel to a power source;
installing a plurality of nodes throughout the building;
wiring the plurality of nodes to the electrical panel with one or more home-run power lines, wherein said wiring substantially minimizes home-run power lines to the electrical panel and substantially minimizes circuit breakers; and
assigning each of the plurality of nodes to either a first zone or a second zone with the wireless controller, wherein one of the plurality of nodes in the first zone and one of the plurality of nodes in the second zone are connected to the electrical panel with the same home-run power line.

10. The method of wiring and zoning a building of claim 9 wherein said wiring consists of wiring the plurality of nodes to the electrical panel with one home-run power line and one circuit breaker.

11. The method of wiring and zoning a building of claim 9 further comprising reassigning one or more of said plurality of nodes to a different zone without changing said wiring.

12. The method of wiring and zoning a building of claim 9 wherein each of the plurality of nodes is a lighting control module integrated into a lighting fixture.

13. The method of wiring and zoning a building of claim 9 further comprising wiring each of the plurality of nodes to one or more lighting fixtures.

14. The method of wiring and zoning a building of claim 13 further comprising powering each of said plurality of nodes through at least one of said connected lighting fixtures.

15. The method of wiring and zoning a building of claim 13 further comprising powering each of the one or more lighting fixtures through each of said connected plurality of nodes.

16. A power and control system for a building comprising:
an electrical panel electrically connected to a power source, wherein said electrical panel includes a control breaker and a branch circuit output;
a plurality of nodes distributed throughout said building connected so as to minimize the amount of wiring connecting the plurality of nodes;
an electrical path between the branch circuit output of the electrical panel and the plurality of nodes so as to minimize the amount of wiring connecting the electrical panel and the plurality of nodes, wherein the control breaker controls power to the plurality of nodes through the branch circuit output; and
a controller for providing wireless control of said plurality of nodes.

17. The power and control system of claim 16 wherein said electrical path between said branch circuit output and said plurality of nodes consists of one home-run.

18. The power and control system of claim 16 wherein each of said plurality of nodes are assigned to a first zone or a second zone, and wherein said controller is capable of providing separate instructions to said plurality of nodes in said first zone than said plurality of nodes in said second zone.

19. The power and control system of claim 16 wherein one or more of said plurality of nodes are reassigned to a different zone without changing the wiring connecting the plurality of nodes or the electrical path between the branch circuit output and the plurality of nodes.

20. The power and control system of claim 16 wherein each of the plurality of nodes is a node integrated into or connected to a fixture.

21. A method of wiring and zoning a building with a wireless controller comprising:
installing an electrical panel in the building with only a single circuit breaker and connecting the electrical panel to a power source;
installing a plurality of nodes throughout the building;
wiring the plurality of nodes to the single circuit breaker in the electrical panel with only a single home-run power line; and
assigning each of the plurality of nodes to either a first zone or a second zone with the wireless controller.

22. A method of retrofitting and zonally controlling a building with a plurality of fixtures distributed throughout the building, the plurality of fixtures connected to a plurality of circuit breakers in an electrical panel by a plurality of home-run power lines, the method comprising:
installing a plurality of wireless control nodes throughout the building;
connecting a power line from each of the plurality of wireless control nodes to one of the fixtures distributed throughout the building;
connecting a control output from each of the plurality of wireless control nodes to at least one of the fixtures distributed throughout the building;
consolidating the plurality of home-run power lines to a single home-run power line that connects to a single circuit breaker;
providing a wireless controller;
assigning each of the plurality of nodes to either a first zone or a second zone with the wireless controller.
reassigning at least one of the plurality of nodes to a different zone, wherein no rewiring is necessary.

23. A power and control system for a building comprising:
an electrical panel electrically connected to a power source;
a plurality of nodes distributed throughout said building connected with a power wiring topology that includes one or more home-runs, wherein the power wiring topology substantially maximizes nodes connected to each home-run such that each home-run reaches its maximum rated capacity before nodes are connected to a different home-run and wherein each of said plurality of nodes is controlled wirelessly; and
a controller for providing wireless zone control of said plurality of nodes, wherein said plurality of nodes may be controlled irrespective of said power wiring topology.
